(19) United States
(12) Patent Application Publication
(10) Pub. No.: US 2013/0006867 A1
(43) Pub. Date: Jan. 3, 2013

(54) SECURE PATIENT INFORMATION HANDLING

(75) Inventors: Bryan Dove, Seattle, WA (US); Sean Nolan, Bellevue, WA (US); John C. Gillotte, Washington, DC (US); Khan M. Siddiqui, Highland, MD (US); Steven J. White, Seattle, WA (US); Sayan D. Pathak, Kirkland, WA (US); Siddhartha K. Singh, Issaquah, WA (US)

(73) Assignee: Microsoft Corporation, Redmond, WA (US)

(21) Appl. No.: 13/172,885

(22) Filed: Jun. 30, 2011

(51) Int. Cl. G06Q 50/00; G06F 17/30; H04L 9/28

(52) U.S. Cl. 705/51; 705/2; 707/827; 707/E17.032

(57) ABSTRACT

The description relates to secure patient information handling. One example can receive encrypted patient data from a first entity. The example can receive a request to view the encrypted patient data from a second entity. The request can include a conditional access code and the example can validate the conditional access code. In an instance where the conditional access code is valid, the example can retrieve an encryption key for the encrypted patient data. The example can decrypt at least a portion of the encrypted patient data to produce decrypted patient data. The example can provide at least some of the decrypted patient data to the second entity.

### BACKGROUND

In the medical setting, the amount of information associated with an individual patient is growing very rapidly. For instance, in imaging and genomic fields the amount of information is increasing at an exponential rate. Cost effective data storage options, such as cloud storage, do not lend themselves to use with patient information due to privacy and security considerations.

### SUMMARY

The description relates to secure patient information handling. One implementation can receive encrypted patient data from a first entity. In this discussion an entity can be thought of as an enterprise, a health care facility or group of health care facilities, or individual health care professionals. The implementation can receive a request to view the encrypted patient data from a second entity. The request can include a conditional access code and the implementation can validate the conditional access code. In an instance where the conditional access code is valid, the implementation can retrieve an encryption key for the encrypted patient data. The implementation can decrypt at least a portion of the encrypted patient data to produce decrypted patient data. The implementation can provide at least some of the decrypted patient data to the second entity.

Another implementation can receive chunks of patient image data in random order. It can determine a logical order for the chunks. The implementation can then upload the chunks for storage according to the logical order.

A further implementation can detect an instance when a patient uploads patient information to a personal health account of the patient. This implementation can monitor copying of image data of the patient information to a remote entity health data storage. It can also copy non-image metadata of the patient information to a local metadata repository that references the image data in the remote entity health data storage.

The above listed examples are intended to provide a quick reference to aid the reader and are not intended to define the scope of the concepts described herein.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1A, 1B, 2A, 2B, and 3 show examples of scenarios for implementing secure patient information handling in accordance with some implementations of the present concepts.

FIG. 4 is an example of a system upon which secure patient information handling can be implemented in accordance with some implementations of the present concepts.

FIGS. 5-7 illustrate examples of flowcharts of secure patient information handling methods in accordance with some implementations of the present concepts.

### DETAILED DESCRIPTION

### Overview

This patent relates to handling patient information in a secure and verifiable manner that is suitable for handling very large amounts of data, such as patient image data. The patient image data can be secured in a manner that allows it to be safely stored by an un-trusted third party.

Among other configurations, the present concepts can be applied to a scenario where the patient information includes patient images or image data and other non-image patient data which may be referred to herein as “metadata”. Considered from one perspective, the present concepts can be thought of as offering secure patient information handling (SPIH). The SPIH concepts can securely manage patient information by encrypting the patient information before sending the patient information into unsecure public environments. Further, the mechanism used to encrypt the patient information (e.g., encryption keys) can be maintained in a secure environment rather than being stored with the patient information. The SPIH concepts can further enable authorized and verified sharing of the stored patient information. Further still, the SPIH concepts can detect instances where the patient uploads patient information into the patient's personal health account and can integrate the patient uploaded information into the system consistent with other patient information.

### Example Scenarios

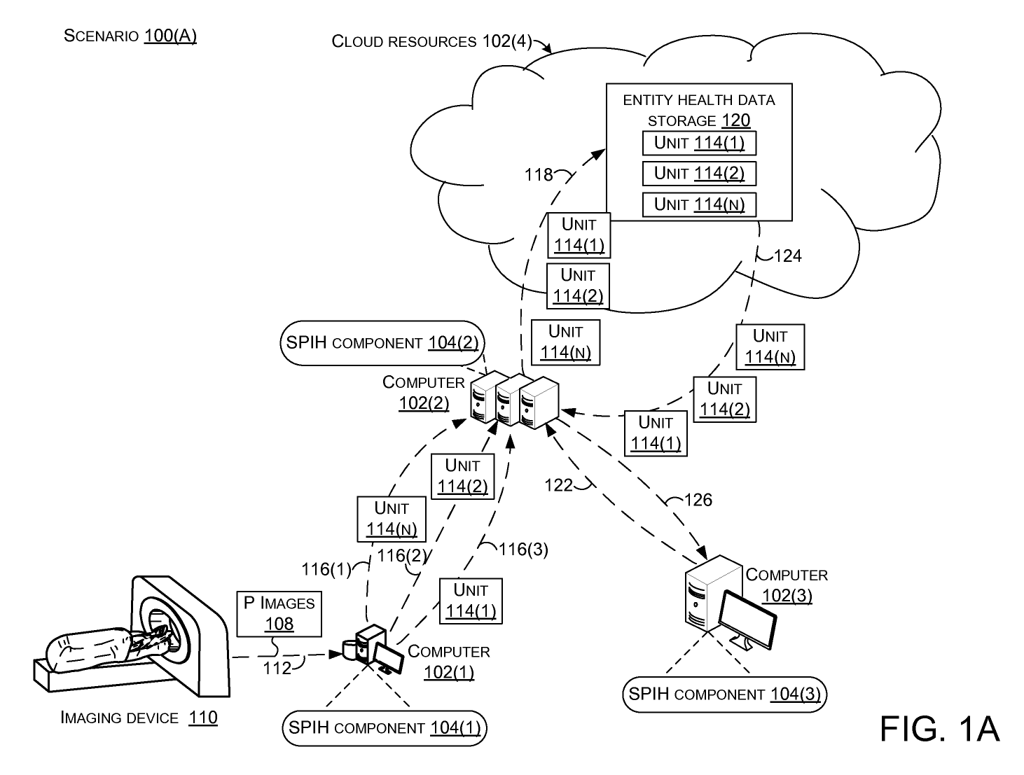

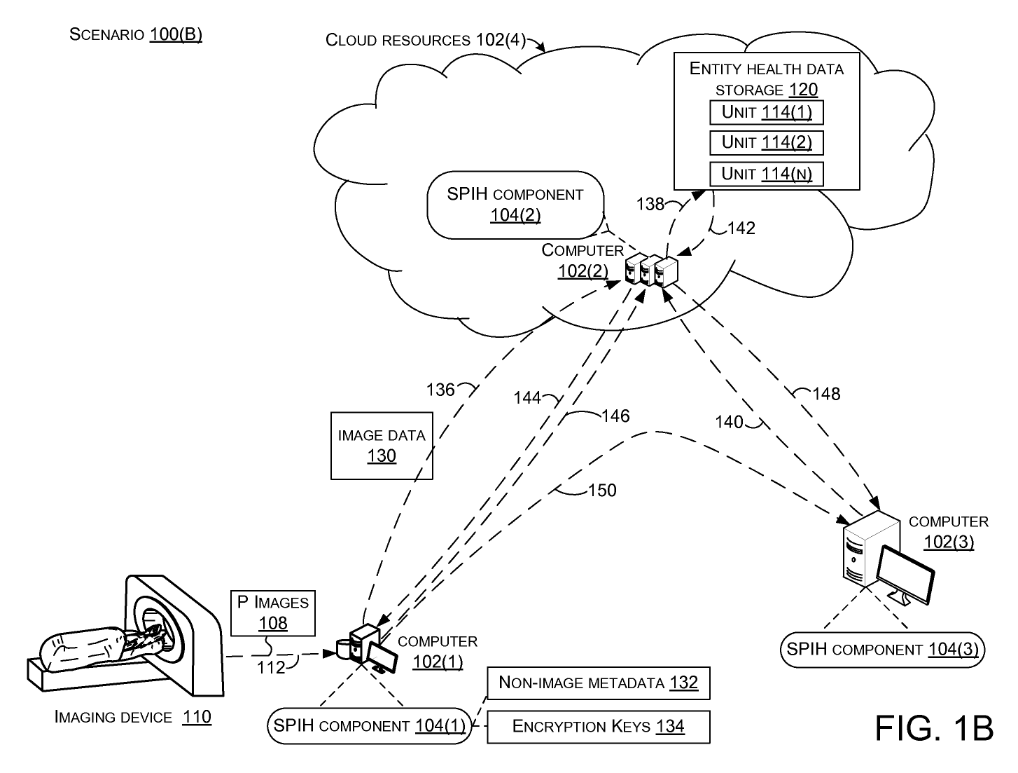

The discussion above broadly introduces SPIH concepts. To aid the reader in understanding these concepts, FIG. 1A illustrates scenario 100(A) that provides a tangible example to which the SPIH concepts can be applied. FIG. 1B provides another example to which the SPIH concepts can be applied. These examples convey concepts related to facilitating patient information downloading and maintaining patient information integrity, among others.

Example scenario 100(A) includes several computers or computing resources. For purposes of explanation, the computers are designated as a computer 102(1), a computer 102(2), a computer 102(3) and cloud resources 102(4). Please note that the concepts explained above and below are applicable to other scenarios involving other computers. Computers 102(1)-102(3) include SPIH components 104(1), 104(2), and 104(3), respectively.

Example scenario 100 involves patient information (e.g. medical records). In this case, the patient information is manifest as patient images 108 captured by imaging device 110. The imaging device is coupled to the computer 102(1) such that patient images 108 can be conveyed from the imaging device 110 to the computer as indicated by arrow 112. In some implementations, SPIH component 104(1) can unitize the patient images into units 114(1)-114(N). SPIH component 104(1) can then send the units to computer 102(2). In some of these implementations, the SPIH component 104(1) can send the units without regard to order. For example, the SPIH component 104(1) can send the units as expeditiously as possible without considering the order of delivery. For instance, in the illustrated scenario the units are communicated in parallel as represented by arrows 116(1)-116(3). In some configurations, as computer 102(2) receives units 114(1)-114(N), the SPIH component 104(2) can calculate a checksum, such as a hash of the individual units and store the units locally, such as in a cache.

The SPIH component 104(2) can determine a logical order for the units. The logical order can be based, at least in part upon consideration of subsequent downloads of the units, e.g. to facilitate downloading of the units. For example, storing the units in sequential order, rather than the received order, may facilitate subsequent downloading. For instance, the patient images 108 may include a series of scans. The scans can be sequentially numbered during the imaging process. An individual scan may be contained in a single unit or may span multiple units. The logical order of the units can be based upon maintaining the scans in sequential order to the extent possible. Such a storage configuration can speed downloading of the units from the perspective of a viewer of the patient images. For instance, if the viewer expects to view the patient images in sequential order, storing the patient images in that order can speed presentation of the initial units to the user while the subsequent units are downloaded.

In some configurations the logical order may include other factors. For instance, the logical order may include the recognition that in some cases there are different types of patient images. For instance, some of the patient images may be key frames while other patient images are non-key frames. The viewer may initially be interested in viewing the key frames. As such the key frames may be organized separately from the other frames. For instance, the logical order may store the key frames in sequential order and then the non-key frames in sequential order so that the key frames are downloaded first in sequential order and then the non-key frames in their sequential order.

Once the SPIH component 104(2) has determined the logical order for the units 114(1)-114(N), the SPIH component can upload the units in the logical order as indicated by arrow 118 into an entity health data storage 120. The entity health data storage can store the units in the received order.

Subsequently, a user may request to view the patient images conveyed in the stored units 114(1)-114(N). For instance, the patient's general practitioner working on computer 102(3) may request the images via SPIH component 104(3). (Note that while only a single instance of the SPIH component 104(2) is illustrated due to space constraints on the drawing page, the SPIH component 104(3) may deal with a separate instance of the SPIH component 104(2) than does SPIH component 104(1)).

The SPIH component 104(3) can request the units either directly from the entity health data storage 120 or indirectly via SPIH component 104(2) as indicated by arrow 122. In the latter case, the SPIH component 104(2) can download the units from the entity health data storage 120 as indicated by arrow 124 and forward the units to the general practitioner's computer 102(3) for viewing as indicated by arrow 126. For ease of explanation, the above described example does not distinguish between handling patient image data and non-image metadata.

In other implementations, the SPIH component 104(1) can receive the patient images 108 and separate the image data of the patient images from the non-image or metadata. For instance, the patient images may contain the actual image data and metadata such as associated tags that identify the patient (e.g., patient name, patient identification number, patient social security number, etc.). Additional metadata may be added to the patient images 108 by the radiologist, among others, such as via computer 102(1). For instance, the radiologist may associate his/her findings with the patient images 108. The SPIH component 104(1) can separate some or all of the non-image data from the image data. The units 114(1)-114(N) can be formed from the image data. The units of image data and the non-image metadata can then be sent separately to computer 102(2).

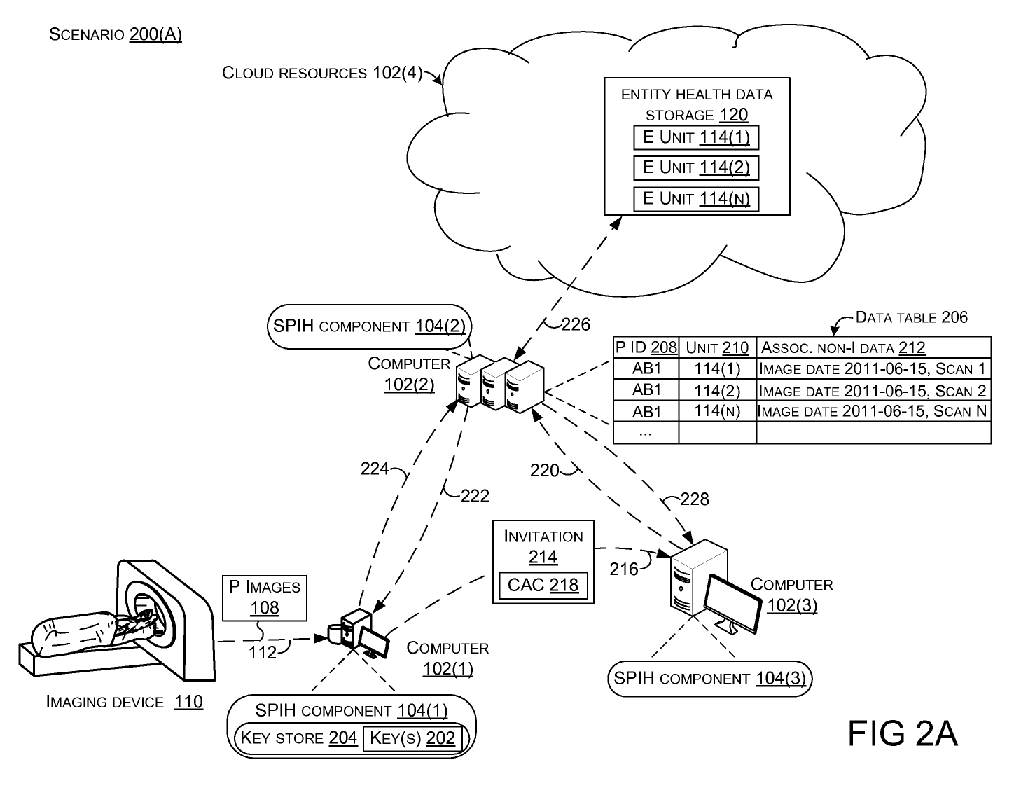

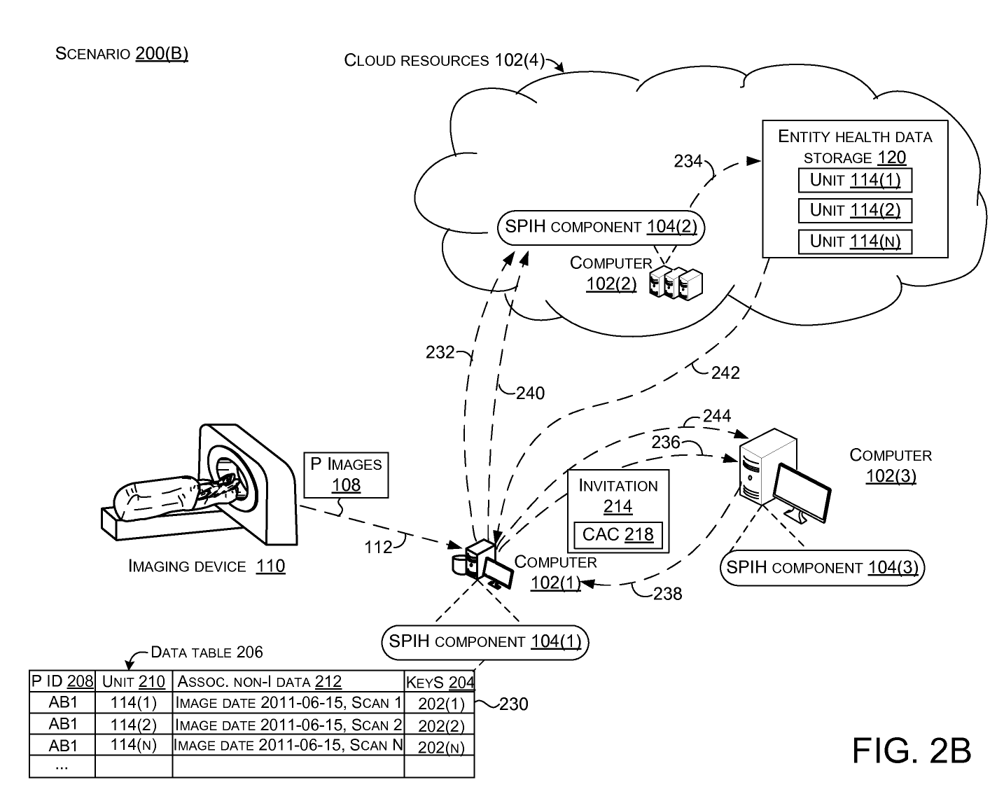

In some implementations, separating the image data from the non-image metadata can serve to anonymize the image data. In other implementations, image data and non-image data are separated, but the image data may retain some metadata, such as text on an x-ray. By storing the non-image metadata separately from the image data, an unauthorized access of the image data in the cloud is less problematic in that the identification of the patient to which the image data belongs can be securely stored away from the cloud, such as by the SPIH component 104(2). As such, the unauthorized party does not know to what patient the image data belongs. Handling of the units of image data and the non-image metadata by the SPIH component 104(2) will be described below relative to FIG. 2A.

FIG. 1B shows another example scenario 100(B) that conveys concepts related to facilitating patient information downloading and maintaining patient information integrity, among others. Several of the elements introduced above relative to FIG. 1A are maintained in FIG. 1B and are not re-introduced here for sake of brevity. In this scenario, computer 102(2) and its SPIH component 104(2) are implemented as a portion of cloud resources 102(4).

In this case, similar to scenario 100(A) computer 102(1) receives patient information in the form of patient images 108 from imaging device 110 as indicated by arrow 112. However, in this example, computer 102(1) via SPIH component 104(1) can separate the patient images into image data 130 and non-image metadata 132. The SPIH component 104(1) can then unitize the image data into one or more chunks (represented as units 114(1)-114(N)). The SPIH component 104(1) can calculate a checksum of each chunk.

The SPIH component 104(1) can encrypt the individual chunks with encryption keys 134. For added security, some implementations can utilize a separate encryption key for each chunk so that a security breach of a single key only exposes a single chunk. The computer 102(1) can store the non-image metadata 132 and the encryption keys 134 and/or otherwise ensure the security of the non-image metadata and the encryption keys. Computer 102(1) can send the unitized image data to computer 102(2) as indicated by arrow 136. SPIH component 104(2) can determine a logical order of the unitized image data and send the unitized image data in the logical order as indicated by arrow 138.

Subsequently, a user may request to view the patient images conveyed in the stored units 114(1)-114(N). For instance, the patient's general practitioner working on computer 102(3) may request the images via SPIH component 104(3). The SPIH component 104(3) can request the units either directly from the entity health data storage 120 or indirectly via SPIH component 104(2) as indicated by arrow 140.

The SPIH component 104(2) can download the units 114(1)-114(N) that contain the requested images from the entity health data storage 120 as indicated by arrow 142. The SPIH component 104(2) can request encryption keys 134 from SPIH component 104(1) as indicated by arrow 144. The SPIH component 104(1) can send one or more of the encryption keys 134 to SPIH component 104(2) as indicated by arrow 146. The SPIH component 104(2) can use the encryption keys to decrypt the downloaded units 114(1)-114(N). The SPIH component 104(2) can perform another checksum on the downloaded units and compare the two checksums to ensure data integrity has been maintained. (Alternatively, the second checksum can be performed by SPIH component 104(3)).

SPIH component 104(2) can send the decrypted units to SPIH component 104(3) as indicated by arrow 148. SPIH component 104(1) can send the corresponding non-image metadata 132 as indicated by arrow 150. SPIH component 104(3) can regenerate the patient images from the decrypted image data received from SPIH component 104(2) and the corresponding non-image metadata received from SPIH component 104(1). SPIH component 104(3) can then make the patient images available to the user on computer 102(3).

Note that since computer 102(2) can operate in an unsecure environment, some implementations can include features to further protect patient data at computer 102(2). For instance, some implementations of computer 102(2) may be disc-less to prevent storage of decrypted patient images. Instead, encrypted units can be downloaded and decrypted using active processor memory. The decrypted units can be sent to computer 102(3). For example, the encrypted units can be decrypted in active processor memory and sent to computer 102(3) without storing the decrypted data or the encryption keys on a disc of computer 102(2).

Also note that while an SPIH component is shown associated with each computer, the functionality offered by the various SPIH components may not be identical. Further, in some instances, the SPIH component may appear to be operating on a specific computer but in fact may be generated remotely. For instance in the example described above where SPIH component 104(3) receives units of image data via arrow 148 and encryption keys and non-image metadata via arrow 150, this SPIH component 104(3) can be manifest as a web-page that is generated remotely, such as by computer 102(1) or 102(2). The web page then obtains the data indicated by arrows 148 and 150 to generate the patient images for a user of computer 102(3).

In some implementations SPIH component 104(2) can be configured to speed delivery of the image data to computer 102(3). For instance, recall that SPIH component 104(2) can receive the encrypted units indicated by arrow 142 responsive to a user request, such as from SPIH component 104(3). Some implementations can speed delivery by rendering the image data and delivering rendered image data at arrow 148. For instance, as the SPIH component 104(2) receives the encrypted units 114(1)-114(N) at arrow 142, the SPIH component 104(2) can decrypt the units and render the images. The rendered images can be much smaller than the stored images. For instance, the units 114(1)-114(N) may be stored uncompressed as raw pixel data. The SPIH component 104(2) can render the images to a relatively data efficient (and/or compressible) format. For example, in one case, the encrypted units can be stored uncompressed in DICOM format. The SPIH component 104(2) can render the image data of the decrypted units into compressed JPEG or other file format. The rendered compressed image data is readily streamed to SPIH component 104(3). In some configurations, the image data can be rendered and streamed in a just-in-time basis to SPIH component 104(3) on computer 102(3) in a manner that can create an impression with a user of computer 102(3) that the patient information is stored locally. This just in time compression and delivery can enhance user satisfaction in that most users want to be able to view the stored patient images with little or no lag time.

To summarize, the above-described configurations can enhance security of the patient information by anonomizing the image data before storing the image data in a potentially unsecure environment. Further, individual units of the image data can be encrypted with individual encryption keys to reduce damage associated with a breached encryption key. Further still, the encryption keys can be stored away from the image data and can be provided to SPIH 102(2) on an as needed basis. Also, the encryption keys can be used and destroyed by SPIH 102(2) without being stored in the potentially unsecure environment.

FIGS. 2A and 2B illustrates further example scenarios 200(A) and 200(B) to which SPIH concepts can be applied. Several of the elements introduced above relative to FIGS. 1A and 1B are maintained in FIGS. 2A and 2B and are not re-introduced here for sake of brevity. These example scenarios convey concepts related to encrypting patient information and accessing encrypted patient information, among others.

Example scenario 200(A) starts very similar to scenarios 100(A) and 100(B). Upon receipt of the patient images 108, the SPIH component 104(1) can segment the patient images into one or more units. In this case, in a first implementation, the SPIH component 104(1) then encrypts the units with an encryption key(s) 202 that is then stored in key store 204. The SPIH component 104(1) can then send the encrypted units to the computer 102(2).

Upon receipt, the SPIH component 104(2) may or may not encrypt the units again (e.g., double encrypted units). The SPIH component 104(2) can upload the encrypted units to the entity health data storage 120 where they are represented as encrypted units (E Units) 114(1)-114(N). In this configuration, the encryption key(s) are not stored with the patient image data (e.g., the encrypted units 114(1)-114(N)) in the cloud resources. Thus, a security breach in the cloud does not risk the privacy of the patient information contained in the encrypted units 114(1)-114(N).

In some implementations, the SPIH component 104(1) on computer 102(1) may distinguish patient images 108 into patient image data and non-image metadata. For instance, the non-image metadata can include, data fields on the patient images, such as patient name, capture date, as well as any accompanying notes, dictation, radiologist's findings, etc. The SPIH component 104(1) can associate the image data and the non-image data via a unique patient ID. The SPIH component 104(1) may encode the patient image data into encoded units 114(1)-114(N) and send the encoded units and the non-image metadata to SPIH component 104(2). The SPIH component 104(2) may save the non-image metadata locally in a data table 206. The data table can relate the non-image metadata to the image data (e.g., encoded units 114(1)-114(N)). For instance, data table 206 can include a patient ID column 208, a unit column 210, and an associated non-image metadata column 212. Thus, the data table can serve to relate non-image metadata stored in the data table with image data stored in the entity health data storage 120.

Of course, the data table 206 may include other data, such as a source of the patient information, storage address, and/or encryption keys (in instances where the units are double-encrypted), among others. Recall that in some implementations, all metadata can be removed from the encoded image data except the patient ID or other reference number used to associate specific image data with specific non-image metadata. Thus, even if the entity health data storage 120 is breached and the encoded units 114(1)-14(N) are decrypted, the image data is rendered relatively meaningless without access to the data table 206 which ties the image data to the patient.

In example scenario 200A the patient's radiologist (via computer 102(1)) may send an invitation 214 to another user to view patient information including patient images 108. In this example, the invitation is sent to computer 102(3) that may be associated with the patient's general practitioner as indicated by arrow 216. The invitation may include a conditional access code (CAC) 218 for the patient information. The conditional access code can allow the recipient to access the encrypted patient image data (e.g., encrypted units 114(1)-114(N)) consistent with any conditions assigned by the SPIH component 104(1). For example, the conditional access code may define whether all or a portion of the encrypted units 114(1)-114(N) may be accessed and/or may define a time period within which the conditional access code is valid, among other conditions.

As indicated by arrow 220, the general practitioner at computer 102(3) can attempt to redeem the conditional access code with the SPIH component 104(2) to obtain the patient information. As indicated by arrow 222, the SPIH component 104(2) can check the validity of the conditional access code with the SPIH component 104(1). If the conditional access code is valid, the SPIH component 104(1) can retrieve the encryption key(s) 202 from the keystore 204 and send the encryption key(s) to the SPIH component 104(2) as indicated by arrow 224. The SPIH component 104(2) can retrieve the encrypted units 114(1)-114(N) (or a sub-set of the units as prescribed by the conditional access code) from the entity health data storage 120 as indicated by arrow 226. The SPIH component 104(2) can decrypt the encrypted units 114(1)-114(N) with the encryption key(s) 202. The SPIH component 104(2) can then recombine the decrypted image data and the non-image metadata from data table 206 to recreate the patient information, including patient images 108. The SPIH component can then send the patient information that includes patient images 108 to computer 102(3) for the general practitioner as indicated by arrow 228.

Accordingly, upon receipt of a request (such as from the general practitioner) to access the patient information (e.g., patient images 108) accompanied by a valid conditional access code, the SPIH component 104(2) may access the data table 206. The SPIH component can retrieve the non-image patient data from the data table and the corresponding encoded units from the entity health data storage 120 and recombine the two types of patient information. Consistent with the above example, the SPIH component 104(2) can then send the recombined patient information to the requesting SPIH component 104(3) for presentation to the general practitioner.

In the case of scenario 200(B) the SPIH component 104(1) can maintain the data table 206. Further, in this instance, the SPIH component 104(1) can treat the key store 204 as a column of the data table 206. Upon receipt of the patient images, SPIH component 104(1) can separate the image data and the non-image metadata. The image data can be unitized and encrypted. A row of the data table can be dedicated to each unit. For instance, the first row 230 of the data table can relate to patient ID “AB1”, unit “114(1)” with corresponding non-image metadata “image data 2011-06-15, scan 1” and encryption key “202(1)”.

The SPIH component 104(1) can send the encrypted units to computer 102(2) as indicated by arrow 232. Upon receipt of the encrypted units, the SPIH component 104(1) can facilitate storage of the units in entity health data storage 120 as indicated by arrow 234.

The SPIH component 104(1) can also send invitation 214 to computer 102(3) to view the patient images 108 as indicated by arrow 236. A user at computer 102(3) can request to view the patient images 108. In such a case, SPIH component 104(3) can communicate the request to SPIH component 104(1) as indicated by arrow 238. Upon verifying the request, SPIH component 104(1) can send a download request to SPIH component 104(2) to obtain the units 114(1)-114(N) from entity health data storage 120 as indicated by arrow 240. The units can be downloaded to computer 102(1) in their stored order as indicated by arrow 242. SPIH component 104(1) can receive individual units and can access the data table 206 to obtain the encryption keys. The SPIH component 104(1) can decrypt the individual units and regenerate the image data utilizing the non-image metadata in the corresponding row of the data table. This regenerated image data can be sent to computer 102(3) as indicated by arrow 244 while remaining units are still being downloaded from the entity health data storage 120. Of course, not all possible variations can be illustrated. For instance, in one case, SPIH component 104(1) can send the data from data table 206 to SPIH component 104(3), such that SPIH component 104(3) could download the units from the entity health data storage 120 and regenerate the patient images with reduced or no further help from SPIH component 104(1).

In still another implementation, after receiving the invitation at 236, the SPIH component 104(3) can attempt to redeem the invitation with SPIH component 104(2). If the conditional access code is valid, SPIH component 104(2) can retrieve the encryption keys 202 from SPIH component 104(1). The SPIH component 104(1) can send the associated non-image metadata 212 to SPIH component 104(3). SPIH component 104(2) can download the units 114(1)-114(N) and decrypt the units using the encryption keys. The SPIH component 104(2) can then send the decrypted units to SPIH component 104(3). The SPIH component 104(3) can then regenerate the patient images from the decrypted units and the associated non-image metadata.

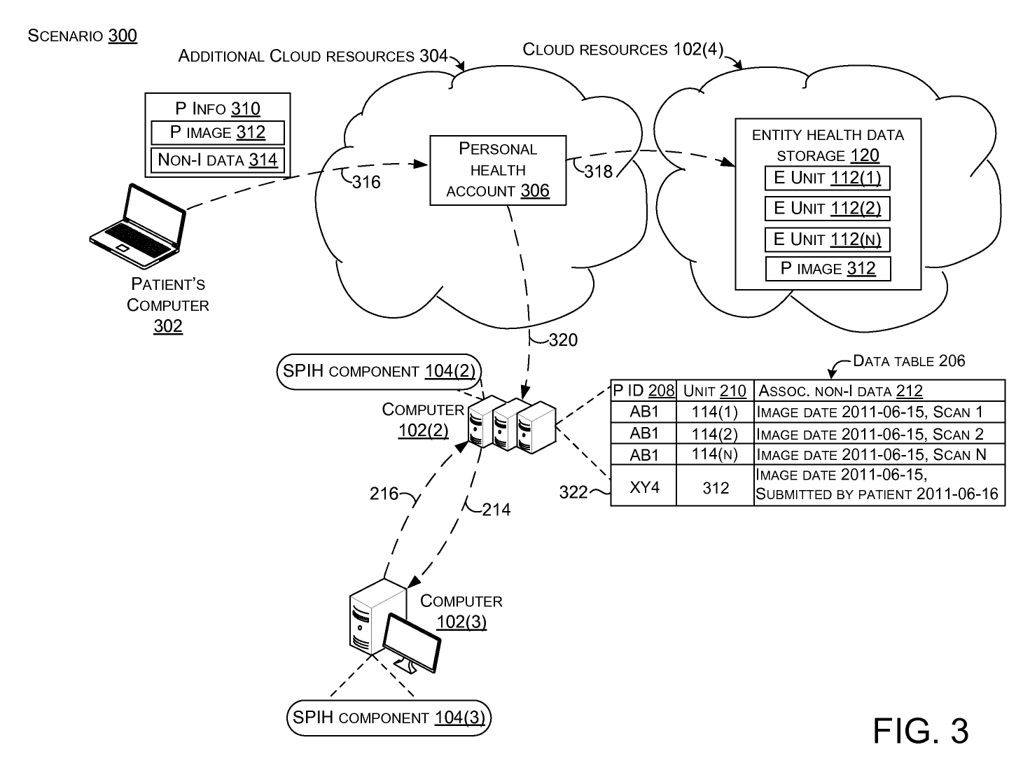

FIG. 3 illustrates another example scenario 300 to which SPIH concepts can be applied. Several of the elements introduced above relative to FIGS. 1A, 1B, 2A, and 2B are maintained in FIG. 3 and are not re-introduced here for sake of brevity. This example scenario conveys concepts related to patient initiated sharing of his/her patient information, among others.

FIG. 3 introduces a patient's computer 302 and an additional cloud resource 304. The cloud resource 304 includes a personal health account 306 that is associated with the same patient as patient's computer 302. In this case, assume that the patient has patient information 310 that the patient wants to be accessible to his/her health care providers (represented by general practitioner's computer 102(3)). In this example, the patient information 310 includes patient image 312 and non-image patient metadata (non-I data) 314. The patient can upload the patient information 310 to his/her personal health account 306 as indicated by arrow 316.

The patient's personal health account 306 may unitize and/or encrypt the patient images 312 as described above relative to FIGS. 1-2, but for sake of brevity assume the patient image 312 can be sent and stored as a single unit and thus is simply referred to as patient image 312 for the remainder of the discussion of FIG. 3. In one implementation, the patient's personal health account 306 can automatically exchange the patient image 312 with the entity health data storage 120 as indicated by arrow 318. The personal health account may also send the non-image data 314 to SPIH component 104(2) as indicated by arrow 320.

The SPIH component 104(2) can add the non-image data to the data table 206 as shown in row 322. The row can associate the patient image 312 that is now stored in the entity health data storage 120 with the patient's unique ID (which in this example is “XY4”) and other non-image metadata of column 212. For instance, the non-image metadata indicates that the image date is 2011-06-15. A notation in column 212 indicates that the patient image 312 was “submitted by the patient on 2011-06-16”. Thereby, a notice can be provided to a future requestor of the patient information 310 that it was submitted by the patient. Thus, the future requestor can be made aware that the patient information may not have the reliability of patient information submitted through a traditional entity such as a health care facility.

In an alternative configuration, the patient image 312 and the non-image data 314 can be sent from the personal health account 306 to the SPIH component 104(2). The SPIH component can add the non-image data to the data table 206 and communicate the image data to the entity health data storage 120 on behalf of the personal health account 306. In some cases, the SPIH component 104(2) may encrypt the image data before uploading it to the entity health data storage 120. In such a case, the SPIH component can maintain the encryption keys, such as in the data table 206.

Also, while not expressly shown, SPIH component 104(2) when receiving patient information from an entity, such as via computer 102(3) can also populate the patient information to the patient's personal health account 306. For instance, the SPIH component 104(2) can receive patient information associated with a patient ID. The SPIH component 104(2) can determine if the patient ID is associated with a personal health account (e.g., is personal health account 306 associated with the same patient ID as the patient information). If so, the SPIH component 104(2) can cause the patient information to be uploaded to the personal health account. The SPIH component 104(2) can then store the non-image metadata of the patient information in data table 206 and upload the image data to entity health data storage 120.

### System Example

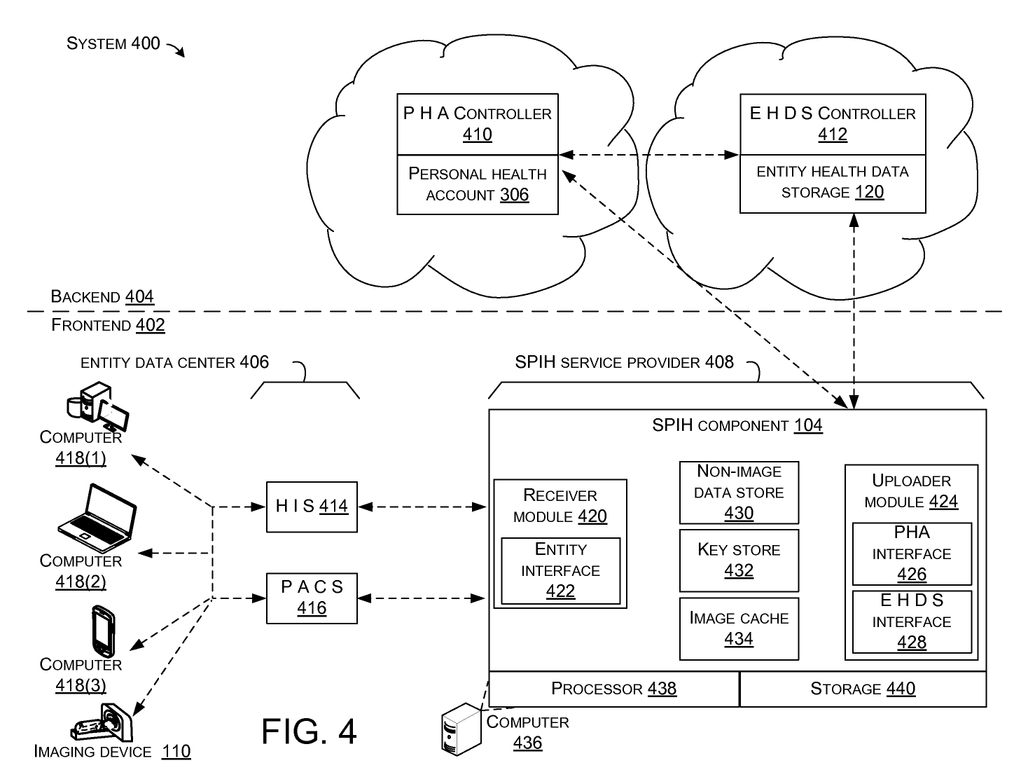

FIG. 4 shows an example of a system 400 that can implement SPIH concepts. For purposes of explanation, system 400 is organized in the context of front end 402 and back end 404 components. Further, the front end 402 is organized into an entity data center 406 and SPIH service provider 408. Further, the front end can be thought of as a secure environment with secure communications. In contrast, the backend can be thought of as an unsecure environment such that it can be assumed that unauthorized access may occur to the data in the back-end either by an insider or external entity. However, such distinction is for ease of explanation and other systems may be implemented in other configurations.

On the back end 404, system 400 introduces a personal health account controller 410 that is associated with the patient's personal health account 306, and an entity health data storage controller 412 that is associated with entity health data storage 120. In some implementations, the entity health data storage controller 412 can be thought of as a feature offered by an SPIH component, such as SPIH component 104(2) of FIG. 2B.

On the front end, the entity data center 406 can include a hospital information system (HIS) 414 and a picture archive communication system (PACS) 416. The entity data center can communicate with various computers 418(1)-418(3) and/or imaging device(s) 110 and the SPIH service provider 408. The SPIH service provider can include SPIH component 104.

In this case, the SPIH component 104 can include a receiver module 420 that interacts with an entity interface 422. The entity interface allows the SPIH component 104 to communicate with the entity data center 406. The SPIH component 104 can also include an uploader module 424, a personal health account interface 426, and an entity health data storage interface 428.

The personal health account interface 426 can facilitate communication between the uploader module 424 and the PHA controller 410. Similarly, the entity health data storage interface 428 can facilitate communication between the uploader module 424 and the EHDS controller 412. Finally, the SPIH component 104 can include a non-image data store 430, a key store 432, and an image cache 434. In an alternative configuration shown in FIG. 3, the functionality of the non-image data store 430 and the key store 432 are provided by the data table 206.

SPIH component 104 can be implemented on one or more computer(s) 436. As illustrated relative to computer 436, the various computers can include a processor 438 and storage 440.

Returning to SPIH component 104, the receiver module 420 and the entity interface 422 can facilitate communications with the entity data center 406. Some implementations of the receiver module 420 and the entity interface 422 can offer multiple sets of communication protocols. Such a configuration enhances the likelihood that the entity data center will recognize one of the set of protocols and thus operate without modification. For instance, one set of currently employed protocols is Digital Imaging and Communications in Medicine (DICOM). For instance, the SPIH component 104 could utilize DICOM protocols for all system communications, or could use DICOM with the entity data center 406 and another protocol for the backend communications.

The SPIH component 104 can prepare patient information received by the receiver module 420 from the entity data center 406 for transmission over the public internet. If the patient information is received in unitized form, the SPIH component 104 can work with the individual received units, otherwise, the SPIH component can unitize the patient information, or more particularly, the image data portion of the patient information.

Further, upon receipt by the receiver module 420, the SPIH component can perform a checksum such as a hash on the image data and store the image data in the image cache 434. Alternatively, the checksum can be performed at the entity data center 406 on the patient information prior to transmission to the SPIH service provider 408. The checksum can be transmitted along with the patient information for subsequent verification of the integrity of the patient information.

The SPIH component 104 can separate the patient information into image data and non-image metadata. The SPIH component 104 can reference both types of data with the patient ID. The SPIH component 104 can remove all other non-image data from the image data. It can then store the non-image data in the non-image data store 430. In an instance where the image data is not received in an encrypted form, or for extra security, the SPIH component can perform encryption on the image data. For example, the SPIH component can generate a unique encryption key for each image or set of images. The SPIH component 104 can then store the encryption keys in the key store 432. The non-image data store can maintain a reference as to which stored keys relate to particular image data.

The SPIH component 104 can also attempt to determine a logical order in which to store the unitized image data. For instance, a potential order that the units might be viewed upon download can be considered as a factor in the logical order. In such a configuration, by storing the first unit first, the viewer may be able to view the first image while the subsequent images are being downloaded.

Once the unitized image data is ready for uploading, the SPIH component 104 can cause the uploader module 424 to upload the unitized image data to the entity health data storage 120 in the logical order. The uploader module 424 can also cause a copy of the patient information or a copy of the unitized image data to be sent to the personal health account 306 of the patient associated with the unique patient ID.

In an instance where the patient uploads patient information to his/her personal health account 306, the personal health account controller 410 can negotiate with the entity health data storage controller 412 and/or the uploader module 424 to cause the patient image data to be disseminated to the entity health data storage 120 and the non-image metadata to be disseminated to the non-image data store 430.

Subsequent to the uploading of patient image data from SPIH service provider 408 to the entity health data storage 120, the SPIH component 104 may receive a request for the patient information from the entity data center 406. For instance, the request may come from one of computers 418(1)-418(3) that has received a conditional access code regarding the patient information. The SPIH component 104 can verify the validity of the conditional access code and then begin the retrieval process for the corresponding image data. In such a case, the uploader module 424 can send a request for units of image data to the entity health data storage 120. The SPIH component 104 can decrypt the image data with the key from the keystore 432 and then recombine the image data with the corresponding non-image metadata from the non-image data store 430 to regenerate the patient information. The validity of the regenerated patient information can be verified by calculating a checksum of the regenerated patient information and comparing to the checksum calculated on the original patient information. The (regenerated) patient information can then be sent to the requesting party.

The term “computer” or “computing device” as used herein can mean any type of device that has some amount of processing capability and/or storage capability. Processing capability can be provided by one or more processors that can execute data in the form of computer-readable instructions to provide a functionality. Data, such as computer-readable instructions, can be stored on storage. The storage can be internal and/or external to the computing device. The storage can include any one or more of volatile or non-volatile memory, hard drives, flash storage devices, and/or optical storage devices (e.g., CDs, DVDs etc.), among others. As used herein, the term “computer-readable media” can include transitory and non-transitory computer-readable instructions. In contrast, the term “computer-readable storage media” excludes transitory instances. Computer-readable storage media includes “computer-readable storage devices”. Examples of computer-readable storage devices include volatile storage media, such as RAM, and non-volatile storage media, such as hard drives, optical discs, and flash memory, among others.

Examples of computing devices can include traditional computing devices, such as personal computers, cell phones, smart phones, personal digital assistants, or any of a myriad of ever-evolving or yet to be developed types of computing devices. Further, aspects of system 400 can be manifest on a single computing device or distributed over multiple computing devices.

### First Method Example

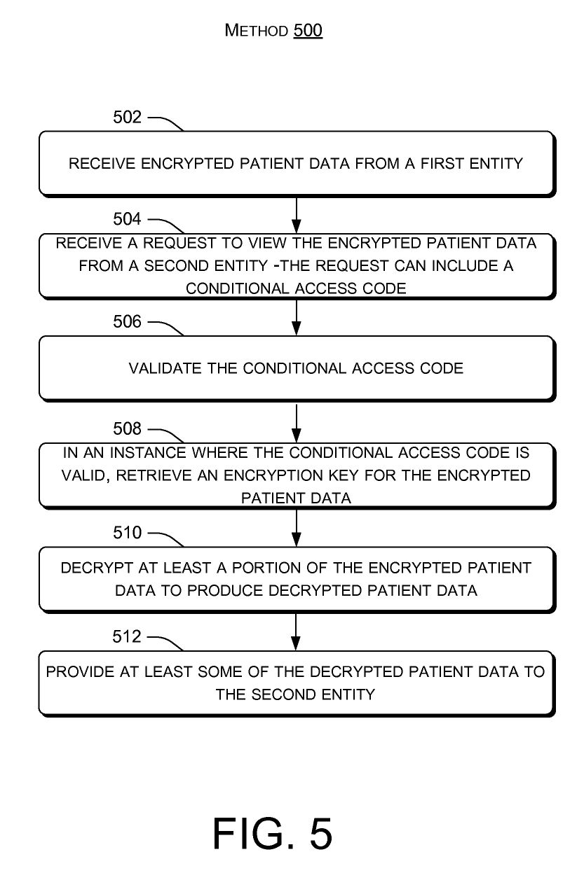

FIG. 5 illustrates a flowchart of a method or technique 500 that is consistent with at least some implementations of the present concepts.

In this case the method can receive encrypted patient data from a first entity at 502.

The method can receive a request to view the encrypted patient data from a second entity, wherein the request includes a conditional access code at 504.

The method can validate the conditional access code at 506. For instance, the method can validate the conditional access code with the first entity.

The method can in an instance where the conditional access code is valid, retrieve an encryption key for the encrypted patient data at 508. In one case, the encryption key can be retrieved from the first entity. In other implementations, a service provider may maintain the encryption key.

The method can decrypt at least a portion of the encrypted patient data to produce decrypted patient data at 510. For instance, the conditional access code may be limited to a sub-set of the patient data. In another case, the requester may only want to view a sub-set of the patient data so only that portion is decrypted.

The method can provide at least some of the decrypted patient data to the second entity at 512. In some cases, the decrypted patient data is patient image data. The patient image data may be combined with non-image data before being provided to the second entity.

### Second Method Example

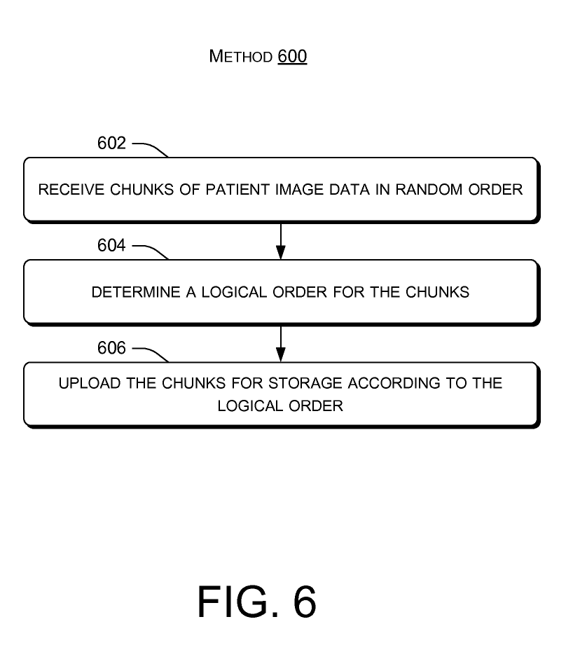

FIG. 6 illustrates a flowchart of a method or technique 600 that is consistent with at least some implementations of the present concepts.

In this case the method can receive chunks of patient image data in random order at 602. For instance, the chunks may be received along multiple parallel paths.

The method can determine a logical order for the chunks at 604. The logical order can be based at least in part on download considerations. For instance, if a potential viewing order that a subsequent requester may want to view the chunks can be determined, then the logical order can be selected to facilitate efficient downloading in the viewing order.

The method can upload the chunks for storage according to the logical order at 606.

### Third Method Example

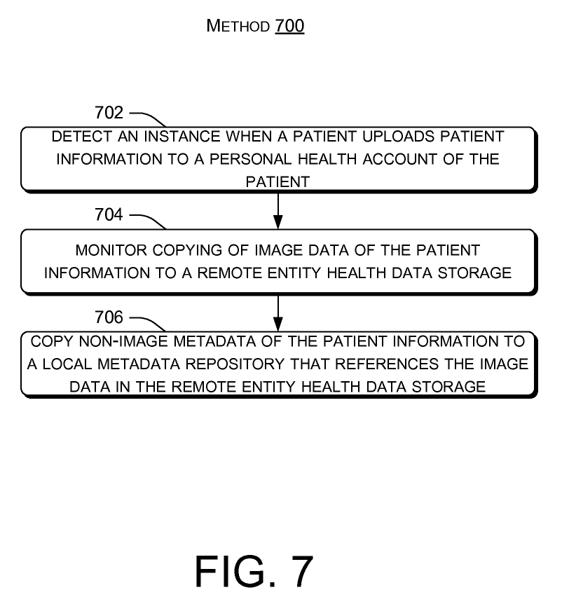

FIG. 7 illustrates a flowchart of a method or technique 700 that is consistent with at least some implementations of the present concepts.

In this case the method can detect an instance when a patient uploads patient information to a personal health account of the patient at 702. In some implementations the patient first establishes consent with an SPIH service provider to upload the patient information. The patient can then upload the patient information from his/her computer to his/her personal health account.

The method can monitor copying of image data of the patient information to a remote entity health data storage at 704. The remote entity health data storage can be known to the SPIH service provider.

The method can copy non-image metadata of the content to a local metadata repository that references the image data in the remote entity health data storage at 706. In some implementations, the personal health account controller can automatically exchange the non-image metadata with the SPIH service provider. The SPIH service provider can then store the non-image metadata in a manner that associates the non-image metadata with the image data stored in the remote entity health data storage. In another case, the personal health account can send all of the patient information to the SPIH service provider. The SPIH service provider can separate the non-image metadata and from the image data. The SPIH service provider can unitize and encrypt the image data. The SPIH service provider can send the unitized encrypted image data to the remote entity health data storage and retain the non-image metadata and the encryption keys.

The order in which the example methods are described is not intended to be construed as a limitation, and any number of the described blocks or steps can be combined in any order to implement the methods, or alternate methods. Furthermore, the methods can be implemented in any suitable hardware, software, firmware, or combination thereof, such that a computing device can implement the method. In one case, the method is stored on one or more computer-readable storage media as a set of instructions such that execution by a computing device causes the computing device to perform the method.

### CONCLUSION

Although techniques, methods, devices, systems, etc., pertaining to secure patient information handling are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. At least one computer-readable storage medium having instructions stored thereon that, when executed by a computing device, cause the computing device to perform acts, comprising:
receiving encrypted patient data from a first entity;
receiving a request to view the encrypted patient data from a second entity, wherein the request includes a conditional access code;
validating the conditional access code;
in an instance where the conditional access code is valid, retrieving an encryption key for the encrypted patient data;
decrypting at least a portion of the encrypted patient data to produce decrypted patient data; and,
providing at least some of the decrypted patient data to the second entity.

2. The computer-readable storage medium of claim 1, wherein the validating comprises validating the conditional access code with the first entity.

3. The computer-readable storage medium of claim 1, further comprising separating the received encrypted patient data into image data and non-image data and uploading the image data to a remote storage resource and maintaining the non-image data locally.

4. The computer-readable storage medium of claim 1, wherein the retrieving comprises retrieving the encryption key from the first entity.

5. The computer-readable storage medium of claim 1, wherein the encrypted patient data comprises anonymized image data, and wherein the providing comprises recombining decrypted image data with corresponding non-image metadata.

6. The computer-readable storage medium of claim 1, wherein the receiving encrypted patient data includes receiving a checksum of the encrypted data from the first entity and subsequent to the decrypting calculating another checksum and verifying data integrity by comparing the checksum and the another checksum prior to the providing.

7. The computer-readable storage medium of claim 1, wherein the retrieving, the decrypting, and the providing are performed on a computing resource without storing the decrypted patient data or the encryption key on a disc of the computing resource.

8. The computer-readable storage medium of claim 1, further comprising rendering the decrypted patient data and wherein the rendering and the providing are performed on a just-in-time basis for the rendered decrypted patient data.

9. A method, comprising:
receiving chunks of patient image data in random order;
determining a logical order for the chunks; and,
uploading the chunks for storage according to the logical order.

10. The method of claim 9, wherein the receiving comprises receiving encrypted chunks.

11. The method of claim 9, further comprising encrypting the received chunks.

12. The method of claim 9, wherein the logical order comprises a sequential order.

13. The method of claim 9, wherein the logical order is selected to facilitate downloading of the chunks.

14. The method of claim 9, wherein the logical order distinguishes key frames of the patient image data from non-key frames of the patient image data and wherein the uploading comprises uploading the key frames in sequential order separately from the non-key frames.

15. At least one computer-readable storage medium having instructions stored thereon that, when executed by a computing device, cause the computing device to perform acts, comprising:
detecting an instance when a patient uploads patient information to a personal health account of the patient;
monitoring copying of image data of the patient information to a remote entity health data storage; and,
copying non-image metadata of the patient information to a local metadata repository that references the image data in the remote entity health data storage.

16. The computer-readable storage medium of claim 15, wherein the monitoring comprises causing the copying of the image data to the remote entity health data storage.

17. The computer-readable storage medium of claim 15, wherein the monitoring comprises causing a notice to be associated with the copied image data indicating that the copied image data was provided by the patient.

18. The computer-readable storage medium of claim 17, wherein the causing comprises overlaying the notice on the copied image data.

19. The computer-readable storage medium of claim 17, wherein the causing comprises placing the notice with the copied non-image metadata.

20. The computer-readable storage medium of claim 15, further comprising responsive to the detecting, performing anonymization of the image data prior to the image data copying.
